(19) United States
(12) Patent Application Publication
(10) Pub. No.: US 2026/0278721 A1
(43) Pub. Date: Sep. 17, 2026

(54) VIOLENCE-REDUCTION PROGRAM DIAGNOSTICS SYSTEM AND METHOD

(71) Applicant: VRP Diagnostics, Denver, CO (US)

(72) Inventors: Lonnie Matt Schaible, Denver, CO (US); Robert Campbell Troyer, Denver, CO (US); Lorine A. Hughes, Larkspur, CO (US); Thomas Brent Gaisford, Los Angeles, CA (US); Wayne Morrow Chancellor, Denver, CO (US)

(73) Assignee: VRP Diagnostics, Denver, CO (US)

(21) Appl. No.: 19/565,284

(22) Filed: Mar. 12, 2026

Related U.S. Application Data
(60) Provisional application No. 63/770,926, filed on Mar. 12, 2025.

(51) Int. Cl. G06Q 50/26

(52) U.S. Cl. CPC G06Q 50/265

(57) ABSTRACT

This invention relates to a method to measure the effectiveness of violence-reduction programs, comprising enrolling a participant in a violence-reduction program, providing a survey instrument with one or more bipolar adjective pairs and behavioral/situational inquiries to the enrolled participant, obtaining responses to the bipolar adjective pairs inquiries, generating a weighted score based on the responses to the survey instrument, reporting the weighted score, and determining the effectiveness of the violence-reduction program.

### CROSS-REFERENCE TO RELATED APPLICATIONS

This application claims the benefit of U.S. Provisional Patent Application No. 63/770,926, entitled “VIOLENCE-REDUCTION PROGRAM DIAGNOSTICS SYSTEM AND METHOD,” filed Mar. 12, 2025, the disclosure of which is hereby incorporated by reference in its entirety.

### FIELD OF THE DISCLOSURE

This disclosure relates to a tool that measures the effectiveness of gun-violence reduction programs. The absence of standardized measurement tools creates significant challenges for policymakers, funding agencies, government agencies, and community organizations seeking to allocate limited resources effectively. Without reliable metrics to distinguish between programs that genuinely reduce violent behavior and those that merely provide temporary behavioral modifications, billions of dollars in public and private funding may be directed toward ineffective interventions. This measurement gap also prevents the identification and replication of successful program elements across different communities and populations.

### BACKGROUND

There are approximately 20,000 gun murders (and another 40,000 non-fatal shootings) in the U.S. annually. Approximately 80% of these shootings are committed by minority males between the ages of 13 and 25.

Numerous academic studies find that effectively reducing gun violence requires both punishment and non-law enforcement programs to steer those engaging in violence to a healthier future. There are thousands of programs in the U.S. allegedly directed toward reducing gun violence. For example, there are over one hundred in Colorado, including over 70 programs in the Denver metro area alone.

There are many different types of violence-reduction programs: mental-health treatment, cognitive behavioral therapy, acupuncture, addiction counseling, art, sports, yoga, chess, entrepreneurship, job training, mentoring, tutoring, life-skills training, nutrition, parenting, pre-natal care, etc. There is no accepted, validated measure applied to any of these programs that establishes whether the programs cause participants to engage in less gun violence. Instead, programs present individual success stories or indirect data about participant behavior (e.g., the number of participants enrolled, increase in participants’ school attendance during the program, decrease in participant arrests during the program, number of times each participant shows up for a program meeting, etc.).

Thus, solutions are desired for determining the effectiveness of violence reduction programs, and ultimately, reducing violence in communities.

### SUMMARY

The disclosed processes include methods to measure the effectiveness of violence reduction programs at both the individual participant level and the aggregate program level. At the individual level, the methods may include enrolling a participant in a violence reduction program, providing a survey instrument with one or more bipolar adjective pair inquiries and related behavioral and situational questions to the enrolled program participant, obtaining responses to the bipolar adjective pair inquiries, generating a weighted score based on the responses to the survey instrument, and reporting the weighted score. The weighted score indicates whether the participant's self-concept, as measured by the instrument, has changed in response to violence reduction interventions. At the aggregate program level, the methods may include aggregating weighted scores across multiple program participants, applying statistical analysis to determine whether observed changes are significant compared to baseline measurements or other comparators, and determining the effectiveness of the violence-reduction program based on the aggregated analysis.

The skilled person will immediately recognize many other variations to the methods of the present disclosure such as by using a different weighted scale, more or fewer bipolar adjective pairs, an alternative participant rating format, alternative user interfaces, and/or different adjective pairs and related situational/behavioral questions. This summary of the disclosure shall not limit the disclosure or any patent claim that matures therefrom, and any patent claim that grants from this disclosure shall instead be construed according to the plain meaning of the language used in the claim in view of its claim dependency and conventional canons of construction.

### BRIEF DESCRIPTION OF THE DRAWINGS

FIG. 1 illustrates an example of a survey instrument in accordance with aspects of the present disclosure.

FIG. 2 illustrates an example system flow of a violence reduction program of the present disclosure.

FIG. 3 illustrates a system diagram to implement a violence reduction diagnostic system of the present disclosure.

FIG. 4 illustrates an example of a method to measure the effectiveness of a violence reduction program.

FIG. 5 shows a diagram of a system including a device that supports a diagnostic system in accordance with aspects of the present disclosure.

### DETAILED DESCRIPTION

The disclosed systems and methods are related to measuring the effectiveness of violence reduction programs, including a survival identity survey instrument. The systems and methods also improve the impact of these programs to reduce gun violence and recognize a meaningful return on the billions of public and private dollars spent on these programs.

Compared to existing programs and processes to reduce violence, which are limited to looking at a participant's behavior during a program (e.g., going to school more often), the disclosed methods include measuring a participant’s “survival identity” at the beginning, during, and at the end of the program, as well as a year after completion of the program.

“Survival identity” may be understood as a set of dimensions to someone’s personality. The sociology discipline known as “identity theory” concludes that all people have many dimensions to their personalities. These different dimensions are more or less prominent in behavior depending on the situation. These identity dimensions are what cause people to behave the way they do in different situations. Identity theorists have also concluded that these dimensions – and their prominence – can be changed.

“Survival identity” may be marked by the prominence of the following seven dimensions: dominance, fatalism, rebelliousness, impulsiveness, aggressiveness/meanness, paranoia, and commitment.

The disclosed methods include a tool – a survey instrument – to measure the existence and prominence of these dimensions at various stages of an individual’s participation in a violence-reduction program. If these dimensions associated with violent behavior are reduced over the course of the program, there is a determination that the program is working at individual and/or aggregate level. Thus, a program’s effectiveness can be measured by administering the survey instrument that measures change in participants’ survival identity.

The disclosed methods support multiple levels of analysis. At the individual participant level, the instrument measures whether a specific participant's survival identity dimensions have changed over time in response to violence reduction interventions, enabling program staff to monitor individual client progress, adapt intervention modes and intensity, and identify participants who may require modified or escalated services. At the aggregate program level, individual participant scores are aggregated across the program population and subjected to statistical analysis to determine whether the program as a whole is producing meaningful changes in survival identity. Aggregate program evaluation may employ contemporary probability and significance testing to assess whether observed changes are statistically significant compared to baseline measurements, control groups, or other comparators. In further embodiments, the system may employ Bayesian statistical approaches. The distinction between individual-level and aggregate-level analysis enables the system to serve both clinical decision-making for individual participants and evidence-based policy evaluation for programs, funding agencies, and other stakeholders.

The purpose of the survival identity instrument is to provide violence reduction efforts with a tool which can be used to dynamically evaluate whether intended changes are occurring among individuals and groups subject to prevention, desistance and other interventions aimed at self-transformation. The instrument assumes that the self-concept, and identity in particular, embody the values and meanings central to an individual and thereby moderate the decisions one makes. There is currently no instrument available which measures dynamic changes in the self that allow interventions to gauge progress towards transforming the individuals they intervene upon on a dynamic and ongoing basis. In this way, the survival identity instrument is akin to other diagnostic tools and indicators which are commonly used in a variety of practices.

This disclosure discusses specific combination of adjectives and underlying dimensions of meaning used to measure the degree to which one’s identity is reflective of counterproductive self-definitions that indicate one’s propensity for engagement in violence.

In alternative embodiments, the survey instrument containing bipolar adjective pairs may be presented through various technological interfaces to accommodate diverse participant populations and enhance engagement. The system may implement voice-guided interactive administration utilizing speech recognition and text-to-speech technologies for participants with limited literacy or visual impairments, gamified interfaces that present adjective pairs as character customization choices within virtual environments to increase participant engagement, adaptive visual scaling that dynamically adjusts from simple slider controls to concrete visual metaphors such as thermometer scales or color gradients based on participant cognitive abilities, multi-modal sensory presentation incorporating tactile feedback and haptic responses corresponding to scale positions, conversational artificial intelligence that elicits violence identity indicators through natural dialogue rather than formal survey questions, augmented reality environments where participants interact with virtual objects representing bipolar adjective concepts overlaid on their real environment, micro-survey progressive disclosure delivering 2-3 questions daily over extended periods through mobile notifications to reduce survey fatigue, collaborative group interfaces enabling multiple participants to complete assessments simultaneously while maintaining individual privacy, context-aware adaptive timing that schedules question delivery based on participant location and emotional state indicators detected through mobile device sensors, and biometric-enhanced validation incorporating physiological monitoring such as heart rate variability or skin conductance to validate response authenticity and identify participants requiring additional support during assessment administration.

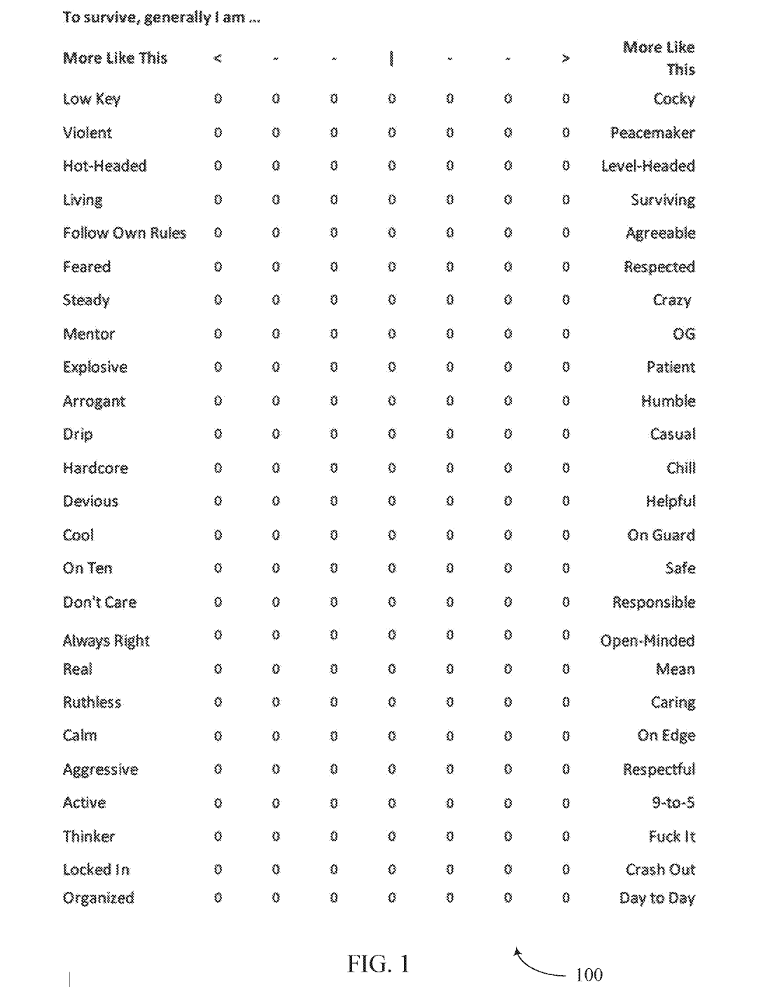

FIG. 1 shows an embodiment of the survey instrument with bipolar adjective pairs. As shown in this example, there are 25 bipolar adjective pairs. In some embodiments, there may be more or fewer than 25 pairs and additional behavioral and situational questions. When completing the instrument, respondents are asked to respond in relation to the prompt “Generally I am …” or a similar prompt. Each adjective pair is ordinally scored from 0-7, by way of example, and weighted based on statistically derived weights to maximize the capability of the instrument to distinguish between individuals who are feared/violent versus others. The adjectives are reverse coded to ensure the direction consistently measures higher survival identity/greater violent propensity. For example: “Low Key – Cocky,” “Violent – Peacemaker,” “Steady – Crazy,” “Living – Surviving,” “Aggressive – Respectful,” “Arrogant – Humble,” “Ruthless – Caring,” “Explosive – Patient.”

In alternative embodiments, the survey instrument may employ methodologies other than bipolar adjective pair rating scales. For example, the instrument may present adjective rank-ordering tasks in which participants arrange adjectives from most to least self-descriptive. The instrument may employ forced-choice pairwise comparisons in which participants select one adjective over another across exhaustive combinations of adjective pairs. The instrument may incorporate perspective-taking prompts that ask participants to evaluate how others perceive them using the adjective dimensions, or to evaluate themselves using adjectives within a specific role, context, or situation. These alternative methodologies may be used independently or in combination with bipolar adjective pair ratings to enhance measurement validity.

The survey instrument tool can take the form of a central component of diagnostic software or applications which can be used by violence prevention efforts to monitor the progress of clients, adapt the mode/intensity of interventions, and report to external stakeholders about progress. For example, the embodiment of FIG. 1 can be embedded into a software system. The software system can be stored on a memory device (e.g., cloud, local server, personal device, etc.). The system and method may be interacted with via a user interface (e.g., personal computer, mobile phone, etc.). The user interface may provide a visual representation of each adjective pair (and related behavioral/situational questions) on a scale (e.g., a slider, radio buttons, numerical scales, or a Likert-style rating scale). As participants respond to adjective pairs and related questions, their responses are stored in a structured format (e.g., in a database or a JSON object). The results may be analyzed according to pre-defined algorithms or, alternatively, artificial intelligence. Such an algorithm may utilize discriminant function analysis to determine the specific weighting which maximizes the difference between types. The instrument may further be used to refine a machine learning model training based on participant data. The software system may report the results via reporting modules to stakeholders.

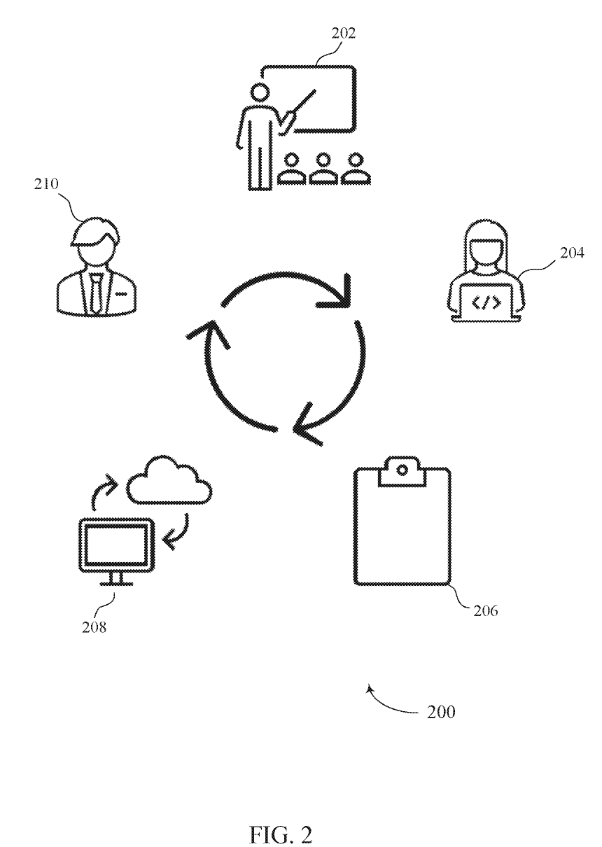

FIG. 2 illustrates an exemplary method 200 for implementing the violence reduction program diagnostics system in accordance with aspects of the present disclosure. The method 400 provides a systematic approach for measuring program effectiveness through participant assessment and stakeholder evaluation.

At step 202, a participant is enrolled in a violence reduction program. The violence reduction program may comprise any of various intervention types including, but not limited to, mental-health treatment, cognitive behavioral therapy, acupuncture, addiction counseling, art therapy, sports programs, yoga, chess instruction, entrepreneurship training, job training, mentoring, tutoring, life-skills training, nutrition counseling, parenting classes, pre-natal care programs, juvenile detention programs, juvenile diversion programs, pre-trial screening and diversion programs, probation supervision programs, parole reentry and supervision programs, court-mandated intervention programs, restorative justice programs, institutional rehabilitation programs within correctional facilities, or other criminal justice system interventions. The enrollment process may include participant registration, consent procedures, and establishment of participant identifiers within the system database.

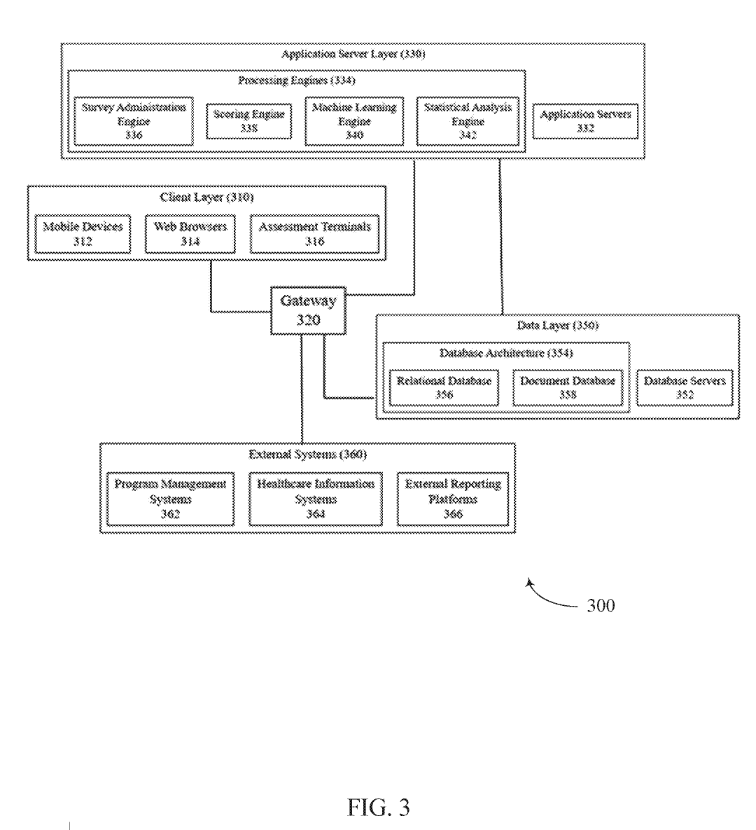

At step 204, the enrolled participant is provided with the survey instrument via a user device or other means. The user device may comprise any of the client devices described in relation to FIG. 3, including mobile devices 312, web browsers 314, or assessment terminals 316. Alternative delivery means may include paper-based instruments, telephone administration through interactive voice response systems, or in-person administration by program staff. The survey instrument contains the bipolar adjective pair inquiries and related behavioral and situational questions as described herein, configured to measure the participant's violence identity across the identified dimensions of dominance, fatalism, rebelliousness, impulsiveness, aggressiveness/meanness, paranoia, and commitment.

At step 206, the participant completes the survey instrument. During this step, the participant responds to each bipolar adjective pair inquiry using the provided rating scale, which may range from 0-7 in certain embodiments. The participant's responses are captured and stored in the system, whether through direct digital input via the user interface or through subsequent data entry for paper-based administrations. The survey completion process may include validation checks to ensure response completeness and data integrity.

At step 208, the system processes the survey responses according to the methods disclosed herein. This processing step may include applying the statistically derived weighting factors to the participant's responses, reverse coding the adjective pairs as appropriate to consistently measure violence propensity, and generating the weighted score that indicates the participant's current survival identity profile. The processing may be performed by the scoring engine 338 and related processing engines 334 described in connection with FIG. 3. Machine learning algorithms may be applied to refine the scoring model based on accumulating participant data.

At step 210, stakeholders evaluate the results of the survey processing. Stakeholders may include program administrators, funding agencies, researchers, policy makers, or other entities with legitimate interests in program effectiveness measurement. The evaluation may involve review of individual participant scores, aggregate program statistics, comparative analyses across different programs or time periods, and assessment of overall program impact on participant survival identity reduction. The results may be presented through reporting modules as described in connection with the system architecture of FIG. 3.

The method 200 may be performed iteratively at multiple time points during a participant's engagement with the violence reduction program, including at program initiation to establish baseline measurements, at intermediate points during program participation to monitor progress, at program completion to assess immediate outcomes, and at follow-up intervals such as one year post-completion to evaluate sustained program effects.

FIG. 3 is a system architecture diagram illustrating an embodiment of a violence-reduction program diagnostics system. The distributed system architecture shown in FIG. 3 provides a framework for collecting, processing, analyzing, and reporting survey data from participants in violence reduction programs to measure program effectiveness and participant progress.

### Client Layer Architecture

The system of FIG. 3 includes a client layer 310 including multiple types of client devices configured to interface with participants and program administrators. Mobile devices 312 may include smartphones, tablets, and other portable computing devices equipped with native mobile applications for iOS and Android operating systems. The mobile devices 312, among other things, provide offline survey capability, enabling participants to complete bipolar adjective pair surveys and behavioral assessments even when network connectivity is unavailable, with automatic data synchronization occurring when connectivity is restored.

Web browsers 314 allow client access through standard web browser applications running on devices such as desktop computers, laptops, or mobile devices. The web browser interfaces may utilize, for example, HTML5, CSS3, and JavaScript technologies to provide interactive survey forms displaying the bipolar adjective pairs (such as “Hard Core - Chill,” “Locked In – Crash Out,” and “Calm – On Edge”) with slider controls, radio button groups, and other user interface elements for participant response collection.

Assessment terminals 316 comprise specialized computing devices deployed at program locations, community centers, or other venues where participants access violence reduction services. These terminals may include kiosks, dedicated workstations, or tablet devices configured specifically for survey administration, providing controlled access environments for participants who may not have personal computing devices.

In alternative embodiments, the client layer 310 may include additional device types such as interactive voice response (IVR) systems for telephone-based survey administration, smart television applications for participants accessing services in residential or custodial facilities, or augmented reality devices for immersive assessment experiences.

### Gateway Architecture

The system of FIG. 3 includes a centralized gateway 320 that serves as the primary communication hub between client devices and server infrastructure. The gateway 320 may implement an Application Programming Interface (API) that accepts requests from client devices and returns responses including survey instruments, participant data, and assessment results (e.g., an API with RESTful web service endpoints that accept HTTP requests from client devices and return JSON-formatted responses).

The gateway 320 may incorporate authentication and authorization mechanisms using techniques such as token-based authentication protocols to ensure secure access to the violence- reduction diagnostics system. Rate limiting functionality prevents system overload and ensures equitable resource allocation among multiple client applications accessing the system simultaneously. The gateway 320 may also implement data validation routines that verify the completeness and integrity of survey responses before processing.

In alternative embodiments, the gateway 320 may implement multiple communication protocols including GraphQL for more flexible data querying, WebSocket connections for real-time survey progress updates, or message queue protocols for handling high-volume survey submission scenarios.

### Application Server Layer

The application server layer 330 of FIG. 3 comprises application servers 332 that execute the logic for violence reduction program diagnostics. The application servers 332 coordinate the operation of multiple processing engines 334 that perform specialized functions related to survey administration, scoring, analysis, and the like. It should be appreciated that alternative embodiment may include different combinations of processing engines to achieve the desired functionality of the embodiment.

The survey administration engine 336 manages the delivery of survey instruments containing bipolar adjective pairs to participants through various interface modalities. This engine dynamically generates user interface elements corresponding to the specific adjective pairs used to measure survival identity dimensions such as dominance, fatalism, rebelliousness, impulsiveness, aggressiveness/meanness, paranoia, and commitment. The survey administration engine 336 may implement session management functionality to track survey progress, handle interruptions, and enable survey resumption when participants need to complete assessments across multiple sessions.

The survey administration engine 336 may prioritize the most statistically informative bipolar adjective pairs based on previous responses and dynamically present survey questions on the user interface. Rather than presenting questions in a fixed sequence, the system may determine information gain metrics for each remaining question and present those with the highest diagnostic value first. This approach reduces survey completion time while maintaining diagnostic accuracy, as the most discriminating questions may be answered when participant attention and engagement are highest.

The survey administration engine 336 may provide adaptive assistance based on response patterns and completion time metrics. If participants spend excessive time on particular bipolar adjective pairs or provide responses that are statistically unusual given their previous answers, the engine may automatically display contextual explanations, example scenarios, or clarification prompts to improve response accuracy.

The scoring engine 338 processes survey response data to generate participant scores that indicate propensity for violent behavior. In some embodiments, the scoring engine 338 may apply weighting factors derived through discriminant function analysis to maximize differentiation between participant risk categories. In some embodiments, the scoring engine 338 may employ logistic regression to estimate the probability that a participant falls within a particular risk category based on the participant's or a cohort’s pattern of survey responses. In some embodiments, the scoring engine 338 may employ Bayesian approaches that start with an initial estimate of a participant's risk level based on prior data and update that estimate as new survey responses or additional data are received. Other statistical and machine learning techniques may also be employed by the scoring engine 338 to optimize which survey items best discriminate between risk categories and to produce risk probabilities for individual participants. For example, responses to the “Cool - On Guard” bipolar adjective pair may receive different weighting than responses to “Real - Mean” based on their statistical correlation with actual violent behavior outcomes, and the selection and weighting of such items may be refined as the system accumulates additional participant data.

The machine learning engine 340 may refine scoring models based on accumulating participant data from multiple violence reduction programs. This module includes aspects such as training data preparation functions, model validation procedures, and prediction accuracy assessment capabilities. The machine learning algorithms may identify previously unknown correlations between specific bipolar adjective pair responses and program success outcomes, enabling continuous improvement of the diagnostic accuracy.

The statistical analysis engine 342 can perform comparative analyses across participant groups, time periods, and program types to evaluate violence reduction program effectiveness. This module executes functions such as correlation calculations, regression analyses, confidence interval computations, and significance testing procedures to determine whether observed changes in participant survival identity scores represent statistically meaningful program impacts.

In alternative embodiments, the processing engines 334 may include additional specialized modules such as a natural language processing engine for analyzing open-ended survey responses, a geographic analysis module for correlating program effectiveness with location-based factors, or a predictive modeling engine for identifying participants at highest risk for program dropout.

### Data Layer Architecture

The data layer 350 includes database servers 352 that manage data storage and retrieval operations for the violence reduction diagnostics system of FIG. 3. The database architecture 354 may employ a hybrid approach combining relational databases 356 for structured data and document databases 358 for unstructured data storage.

The relational database 356 stores participant records including demographic information, program enrollment dates, assessment schedules, and participation status using normalized table structures with defined relationships and constraints. Survey instrument definitions specify the particular bipolar adjective pairs, weighting factors, and scoring algorithms used for each assessment. Response data tables store individual survey answers with timestamps, session identifiers, and data validation flags to maintain data integrity and enable audit tracking.

The document database 358 stores configuration files, algorithm definitions, report templates, and audit logs in JSON document format. This approach provides flexibility for evolving data structures while maintaining referential integrity for core operational data. For example, new bipolar adjective pairs can be added to survey instruments without requiring database schema modifications.

Data synchronization processes may ensure consistency across distributed database instances, with real-time replication mechanisms maintaining current data copies across multiple geographic locations for disaster recovery and performance optimization.

In alternative embodiments, the database architecture 354 may include additional storage technologies such as time-series databases for storing participant score trends over time, graph databases for analyzing relationships between participants and program components, or blockchain-based storage for immutable audit trails of assessment data.

### External Systems Integration

The system of FIG. 3 provides integration capabilities with external systems 360 to support comprehensive violence reduction program management and reporting. Program management systems 362 may include case management software used by community organizations, court systems, or social service agencies to track participant enrollment and program completion. Healthcare information systems 364 enable integration with electronic health records, mental health treatment platforms, and substance use disorder treatment systems to provide holistic participant care coordination. External reporting platforms 366 facilitate data sharing with funding agencies, research institutions, and policy makers who require aggregate program effectiveness data. These integrations support evidence-based policy development and resource allocation decisions for violence reduction initiatives.

The gateway 320 may implement integration adapters that translate data between different format requirements and communication protocols while maintaining data integrity and security standards. For example, participant progress data may be automatically transmitted to probation management systems when participants are involved in the criminal justice system.

In alternative embodiments, external systems integration may include connections to educational information systems for participants in school-based programs, employment services platforms for job training initiatives, public health surveillance systems for community-wide violence prevention monitoring, juvenile justice information systems for tracking youth participants across detention and diversion programs, pre-trial services databases for participants in pre-trial screening and diversion programs, parole supervision platforms for participants in reentry programs, correctional facility management systems for participants in institutional rehabilitation programs, or court case management systems for participants in court-mandated interventions .

### Security and Operational Considerations

The system architecture may implement security measures (not shown in FIG. 3) to protect sensitive participant information while enabling effective program evaluation. Client-server communications can utilize Transport Layer Security (TLS) encryption protocols, while database storage employs field-level encryption for personally identifiable information. Role-based access control mechanisms can ensure that program administrators can access aggregate reporting functions while preventing unauthorized access to individual participant identifiers.

The distributed architecture of FIG. 3 provides scalability to support multiple violence reduction programs simultaneously, with load-balancing capabilities ensuring consistent system performance as participant enrollment grows. This technical architecture enables the implementation of the violence reduction program diagnostics method described herein, providing the computing infrastructure necessary to measure changes in participant survival identity through systematic administration of bipolar adjective pair surveys and generation of weighted scores indicating program effectiveness.

It should be appreciated that an embodiment like that of FIG. 3 can yield technical advantages across systems and processes, including one or more of:

Faster survey data processing due to the reduction or elimination of manual survey administration procedures, manual scoring calculations, and manual report generation through automated algorithmic processing components executing weighted scoring algorithms and statistical analysis functions.

Reduced processing and memory demand due, at least in part, to a distributed computing architecture's dynamic load balancing across multiple application servers, eliminating computational bottlenecks from centralized processing systems and reducing redundant data operations through the multi-database hybrid storage approach.

Reduced processing and memory demands through offline survey capability with automatic data synchronization, eliminating continuous network connectivity requirements and reducing real-time data transmission overhead during survey administration sessions.

Improved diagnostic accuracy due in part to machine learning processing modules that implement adaptive algorithms for refining scoring models based on accumulating participant data, eliminating static scoring limitations and enabling continuous improvement of survival identity measurement precision through discriminant function analysis.

Reduced network bandwidth usage due to a reduction in data transmission resulting from the elimination of manual data entry processes, paper-based survey administration, redundant database queries, and unnecessary client-server communications through API gateway optimization and session management functionality.

Improved program evaluation efficiency due to real-time statistical analysis and automated report generation, reducing or eliminating delayed assessment responses and manual data aggregation procedures that previously required weeks of processing time for program effectiveness determination.

Enhanced longitudinal program monitoring through automated participant progress tracking and cohort benchmarking across multiple violence reduction programs, reducing or eliminating manual data correlation procedures and enabling real-time program effectiveness comparisons based on standardized survival identity metrics.

Improved data integrity and security through field-level encryption of sensitive participant information combined with role-based access control mechanisms, eliminating unauthorized data exposure risks while maintaining research data utility for program evaluation purposes.

Reduced system integration complexity through standardized API gateway interfaces that facilitate connections with external program management systems, healthcare information systems, and reporting platforms, eliminating custom integration development and data format translation procedures.

Enhanced scalability through the distributed server architecture supporting concurrent survey sessions across multiple violence reduction programs simultaneously, eliminating single-system processing limitations and enabling expansion to serve additional programs without architectural modifications.

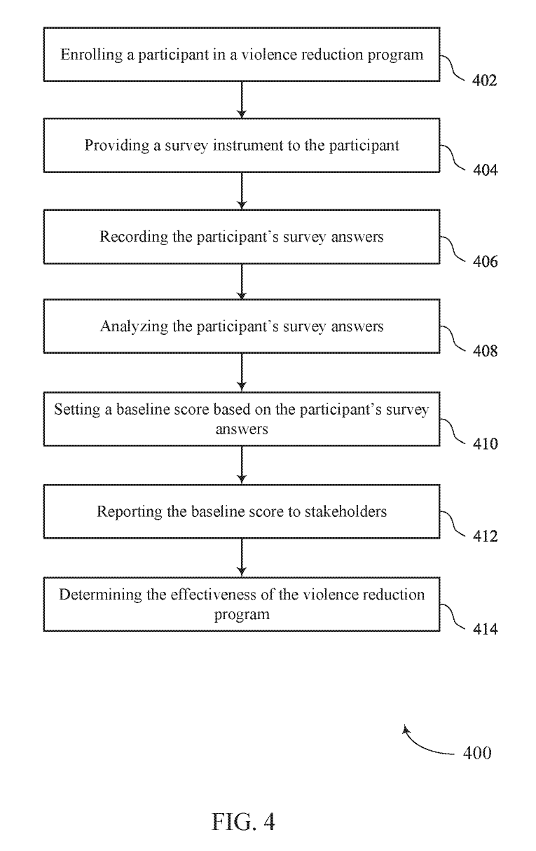

FIG. 4 shows an embodiment of a method of the present disclosure. The method is performed to measure the effectiveness of violence reduction programs and ultimately reduce violence. At 402, participants are enrolled and/or participate in violence reduction programs, such as mental-health treatment, cognitive behavioral therapy, acupuncture, addiction counseling, art, sports, yoga, chess, entrepreneurship, job training, mentoring, tutoring, life-skills training, nutrition, parenting, pre-natal care, etc. At 404, the participant will be provided with a survey instrument as described in this disclosure, such as the survey of FIG. 1. At 406 and 408, the responses of the participant are recorded and analyzed. At 410, based on the analyzed answers, a baseline score is set regarding the propensity of the participant to commit violence. That and subsequent, evolving scores of the participant can then be used to evaluate the effectiveness of the violence reduction program. At 412, the scores can be reported to stakeholders. In some embodiments, the participant will be provided with the survey instrument before, during, and after the violence reduction program to determine how their profile has changed. At 414, the effectiveness of the violence reduction program may be determined.

In embodiments with a mobile application, the method may include setting up a participant account and profile, prompting an initial survey instrument to personalize the application with an initial weighted score, choosing violence reduction programs from a list of curated or personally suggested programs based on the participant profile, enrolling in the violence - reduction program(s) from the mobile application, periodically prompting the survey instrument to obtain new weighted scores over time, and determining the effectiveness of chosen violence reduction programs over time.

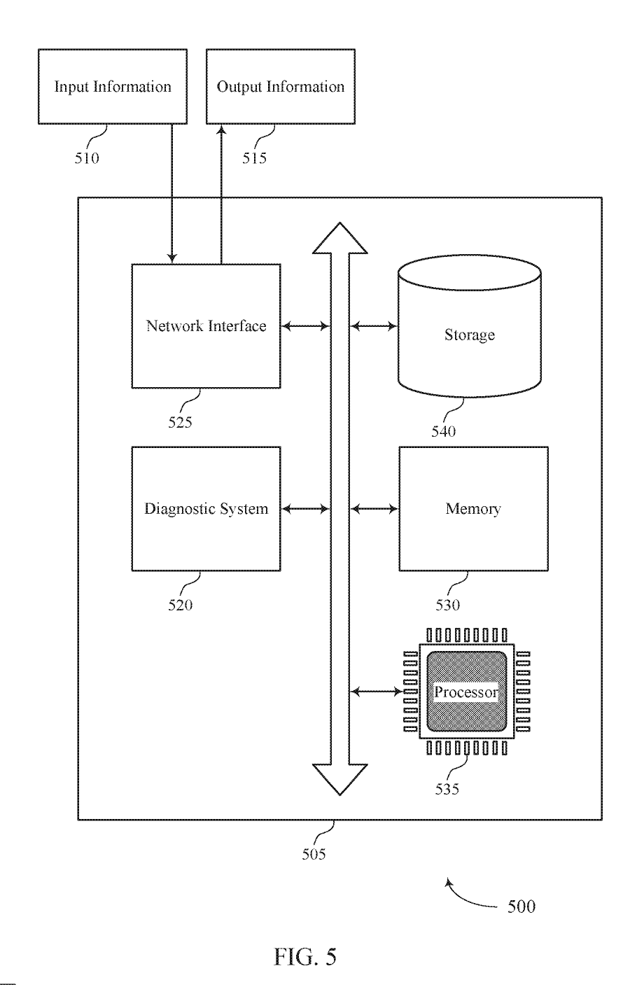

FIG. 5 shows a diagram of a system 500 including a device 505 that supports a violence-reduction program diagnostics system with multi-participant assessment capabilities in accordance with aspects of the present disclosure. The device 505 may be an example of or include components as described herein with reference to FIG. 3. The device 505 may include components for bi-directional voice and data communications including components for transmitting and receiving communications, such as a diagnostic system 520, an input information 510, an output information 515, a network interface 525, at least one memory 530, at least one processor 535, and a storage 540. These components may be in electronic communication or otherwise coupled (e.g., operatively, communicatively, functionally, electronically, electrically) via one or more buses (e.g., communication links, communication interfaces, or any combination thereof). It should be noted that the methods described above describe possible implementations, and that the operations and the steps may be rearranged or otherwise modified and that other implementations are possible. Further, aspects from two or more of the methods may be combined.

The network interface 525 may enable the device 505 to exchange information (e.g., input information 510, output information 515, or both) with other systems or devices (not shown). For example, the network interface 525 may enable the device 505 to connect to a network or function as a network (e.g., such as the gateway described herein with reference to FIG. 3). The network interface 525 may include one or more wireless network interfaces, one or more wired network interfaces, or any combination thereof.

Memory 530 may include RAM, ROM, or both. The memory 530 may store computer-readable, computer-executable software including instructions that, when executed, cause at least one processor 535 to perform various functions described herein, such as functions supporting violence-reduction program diagnostics with bipolar adjective pair survey administration and weighted scoring analysis. In some cases, the memory 530 may contain, among other things, a basic input/output system (BIOS), which may control basic hardware or software operation such as the interaction with peripheral components or devices. In some cases, the memory 530 may be an example of aspects of one or more components of the application server layer 330 as described with reference to FIG. 3. The memory 530 may be an example of a single memory or multiple memories. For example, the device 505 may include one or more memories 530.

The processor 535 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 535 may be configured to execute computer-readable instructions stored in at least one memory 530 to perform various functions (e.g., functions or tasks supporting violence-reduction program diagnostics with survey instrument processing and effectiveness measurement). Though a single processor 535 is depicted in the example of FIG. 5, it is to be understood that the device 505 may include any quantity of one or more of processors 535 and that a group of processors 535 may collectively perform one or more functions ascribed herein to a processor, such as the processor 535. The processor 535 may be an example of a single processor or multiple processors. For example, the device 505 may include one or more processors 535.

Storage 540 may be configured to store data that is generated, processed, stored, or otherwise used by the device 505. In some cases, the storage 540 may include one or more HDDs, one or more SDDs, or both. In some examples, the storage 540 may be an example of a single database, a distributed database, multiple distributed databases, a data store, a data lake, or an emergency backup database. In some cases, the memory 530 may be an example of aspects of one or more components of the data layer 350 as described with reference to FIG. 3.

For example, the diagnostic system 520 may be configured as or otherwise support a means for enrolling participants in violence reduction programs and administering survey instruments containing bipolar adjective pair inquiries. The diagnostic system 520 may be configured as or otherwise support a means for receiving survey responses from enrolled participants via client devices. The diagnostic system 520 may be configured as or otherwise support a means for processing bipolar adjective pair responses to measure survival identity dimensions including dominance, fatalism, rebelliousness, impulsiveness, aggressiveness/meanness, paranoia, and commitment. The diagnostic system 520 may be configured as or otherwise support a means for generating weighted scores based on statistically derived weights applied to survey responses. The diagnostic system 520 may be configured as or otherwise support a means for determining program effectiveness by comparing weighted scores across multiple assessment time periods. The diagnostic system 520 may be configured as or otherwise support a means for generating reports for stakeholders based on participant progress and program effectiveness measurements. The diagnostic system 520 may be configured as or otherwise support a means for implementing machine learning algorithms to refine scoring models based on accumulating participant data from multiple violence reduction programs.

By including or configuring the diagnostic system 520 in accordance with examples as described herein, the device 505 may support techniques for improved violence reduction program evaluation, enhanced participant progress monitoring, reduced manual assessment procedures, and improved coordination between violence reduction programs and stakeholders, among other examples.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed:

1. A method to measure effectiveness of a violence reduction program, comprising:
enrolling a participant in a violence reduction program;
providing a survey instrument with one or more bipolar adjective pair inquiries and related behavioral/situational questions to the enrolled participant;
obtaining responses to the bipolar adjective pairs and related inquiries;
generating a weighted score based on the responses to the survey instrument; and
reporting the weighted score.

2. The method of claim 1, further comprising:
providing a second survey instrument with one or more bipolar adjective pair and related inquiries to the enrolled participant;
obtaining a second set of responses to the bipolar adjective pairs and related inquiries;
generating a second weighted score based on the responses to the survey instrument;
reporting the second weighted score;
evaluating the first and second weighted scores in comparison to each other; and
determining the effectiveness of the violence-reduction program based on an evaluation of the weighted scores.

3. The method of claim 2, further comprising:
measuring change in the participant’s survival identity based on the evaluation of the weighted score.

4. The method of claim 3, wherein the survival identity is measured by identification of at least one of the following dimensions: dominance, fatalism, rebelliousness, impulsiveness, aggressiveness/meanness, paranoia, and commitment.

5. The method of claim 1, further comprising:
reiteratively performing the method to measure effectiveness of a violence reduction program.

6. The method of claim 1, further comprising:
performing the method to measure effectiveness of a violence reduction program at predetermined time intervals.

7. The method of claim 6, wherein the predetermined time intervals include a time period at the beginning of the program, a time period during the program, and a time period at the completion of the program.

8. The method of claim 7, wherein the predetermined time intervals include a time period a year after completion of the program.

9. The method of claim 1, wherein the survey instrument includes 25 bipolar adjective pairs and related behavioral/situational inquiries.

10. The method of claim 1, wherein each score is weighed based on statistically derived weights.

11. The method of claim 1, wherein the bipolar adjective pairs and the related inquiries are reverse coded to measure a propensity for violence.

12. The method of claim 4, further comprising:
determining that a violence-reduction program is effective based on a reduced level of at least one of the dimensions.

13. The method of claim 4, further comprising:
setting a baseline score based on the responses to the survey instrument; and
reporting the baseline score to stakeholders.

14. A violence reduction program diagnostic system, comprising:
one or more client devices, including a client user interface, configured to:
collect participant records from one or more participants enrolled in one or more violence reduction programs,
display a survey instrument to one or more participants on the client user interface, and
collect survey responses from the one or more participants;
a diagnostic system, including:
a gateway configured to manage communication between the one or more client devices and the diagnostic system;
an application server layer, including a processor, configured to:
generate the survey instrument,
process the survey responses received from the one or more client devices,
generate one or more participant scores based on the processed survey responses, and
generate stakeholder information; and
a data layer, including a database, configured to store the participant records, the survey responses, the one or more participant scores, and the stakeholder information.

15. The system of claim 14, further comprising:
one or more external stakeholder systems, including a stakeholder user interface, configured to:
communicate with the gateway,
receive the stakeholder information, and
display the stakeholder information on the stakeholder user interface.

16. The system of claim 14, the application server layer further configured to determine an effectiveness of the one or more violence-reduction programs by comparing the one or more participant scores across the one or more violence reduction programs for the one or more participants.

17. A non-transitory computer-readable medium storing instructions that, when executed by at least one processor, cause the processor to:
administer a survey instrument to one or more enrolled participants in a violence-reduction program on one or more user devices over multiple assessment time periods, the survey instrument containing one or more bipolar adjective pair inquiries configured to measure one or more survival identity dimensions;
receive survey responses from the one or more enrolled participants;
process the survey responses to generate weighted scores indicating a propensity for violent behavior;
compare the weighted scores across the multiple assessment time periods; and
generate stakeholder reports based on violence reduction program effectiveness measurements derived from the weighted score comparisons.
